(19) United States
(12) Patent Application Publication
(10) Pub. No.: US 2020/0224901 A1
(43) Pub. Date: Jul. 16, 2020

(54) CONFIGURABLE DISPLAY FOR SENSOR DEVICE

(71) Applicant: JOHNSON CONTROLS TECHNOLOGY COMPANY, Auburn Hills, MI (US)

(72) Inventors: Daniel J. SPORS, West Bend, WI (US); Brian D. KLARKOWSKI, Wauwatosa, WI (US)

(21) Appl. No.: 16/246,064

(22) Filed: Jan. 11, 2019

(51) Int. Cl. F24F 11/30; F24F 11/52; F24F 11/70; G05D 23/19; G06F 3/041

(52) U.S. Cl. CPC F24F 11/30; F24F 11/52; F24F 2110/10; G05D 23/1902; G06F 3/0412; F24F 11/70

(57) ABSTRACT

A sensor device or thermostat for use in a building zone including a number of sensor components, each sensor component configured to sense an environmental condition. The sensor device or thermostat further including a display. The display including a first number of fixed segment icons, each fixed segment icon associated with one of the sensor components, a first number of fixed segment numerals, each numeral associated with one of the fixed segment icons to indicate a value associated with a sensor component. The display further including a second number of fixed segment numerals, the second number of fixed segment numerals having a larger size than the first number of fixed segment numerals, a user input device configured to receive a user input, and a control circuit communicably coupled to the sensor components, the display, and the user input device, wherein the control circuit is structured to, in a response to a user input selecting one of the number of sensor components, cause the second number of fixed segment numerals to display a value associated with the selected sensor component.

### BACKGROUND

The present disclosure relates generally to sensors and thermostats for heating, ventilation, and air conditioning (HVAC) systems. The present disclosure relates more particularly to user interfaces of the sensors and thermostats.

A building can include an HVAC system airside system including an air handler unit (AHU), multiple variable air volume units (VAVs) associated with various zones, residential heating or cooling units, a number of sensors and/or thermostats to provide environmental measurements, and a building management system (BMS) configured to control the AHU and/or the VAVs. The BMS can be configured to regulate the air temperature of the zones by modifying the control of heating and cooling in the zones. The sensor device or thermostat can include a display allowing user interaction. Many different environmental conditions and parameters relating to the operation of the HVAC system exist. A sensor or thermostat display capable of displaying many different parameters relating to the operation of the HVAC system may be desirable to improve the usability of the device.

### SUMMARY

One implementation of the present disclosure includes a sensor device or thermostat for use in a building zone including a number of sensor components, each sensor component configured to sense an environmental condition. The sensor device or thermostat further including a display. The display including a first number of fixed segment icons, each fixed segment icon associated with one of the sensor components, a first number of fixed segment numerals, each numeral associated with one of the fixed segment icons to indicate a value associated with a sensor component. The display further including a second number of fixed segment numerals, the second number of fixed segment numerals having a larger size than the first number of fixed segment numerals, a user input device configured to receive a user input, and a control circuit communicably coupled to the sensor components, the display, and the user input device, wherein the control circuit is structured to, in a response to a user input selecting one of the number of sensor components, cause the second number of fixed segment numerals to display a value associated with the selected sensor component.

In some embodiments, the control circuit is further structured to, in response to a user input to display an environmental condition value, cause the first number of fixed segment numerals to display a value of the environmental condition sensed by the selected sensor component. In some embodiments, the control circuit is further structured to, in response to a user input to display a set point value, cause the first number of numerals to display a set point for the environmental condition associated with the selected sensor component. In some embodiments, the control circuit is further structured to, in response to a user input to display an environmental condition value, cause the second number of fixed segment numerals to display a value of the environmental condition sensed by the selected sensor component. In some embodiments, the control circuit is further structured to, in response to a user input to display a set point value, cause the second number of numerals to display a set point for the environmental condition associated with the selected sensor component. In some embodiments, the display includes a touch-sensitive display including a number of touch-sensitive user input buttons and the user input device includes the number of touch-sensitive buttons.

In some embodiments, the number of sensor components include, a temperature sensor configured to sense temperature in the building zone, a humidity sensor configured to sense humidity in the building zone and a carbon dioxide sensor configured to sense the carbon dioxide level in the building zone. The number of fixed segment icons includes a temperature icon associated with the temperature sensor, a humidity icon associated with the humidity sensor, and a carbon dioxide icon associated with the carbon dioxide sensor. In some embodiments, the number of sensor components further includes an occupancy sensor configured to sense the presence of a person in the building zone.

In some embodiments, the control circuit is configured to, in response to a user input selecting for display one of the number of fixed segment icons, cause the selected fixed segment icon and the associated fixed segment numeral to illuminate. In some embodiments, the control circuit is configured to, in response to a user input deselecting for display one of the number of fixed segment icons, cause the deselected fixed segment icon and the associated fixed segment numeral to darken.

In some embodiments, the sensor device or thermostat further includes a second number of fixed segment icons, each configured to display a status of a component of an HVAC system. In some embodiments, the display includes a touch-sensitive display including an up button, a down button, and a menu button. In some embodiments, the display further includes a fixed segment temperature display arranged to indicate either degrees Celsius or degrees Fahrenheit. In some embodiments, the control circuit is structured to, in response to the up button and the down button being simultaneously pressed for a predetermined amount of time, cause the display to enter into a configuration mode, wherein, with the display in the configuration mode, the control circuit is structured to in response to a press of the menu button change from a first edit mode for changing the fixed segment temperature display between degrees Celsius and degrees Fahrenheit to a second edit mode for changing a different display feature.

In some embodiments, the second edit mode is for changing each of the fixed segment graphic icons between an illuminated state and a darkened state. In some embodiments, in the first edit mode, the control circuit is structured to cycle between degrees Celsius and degrees Fahrenheit in response to a press of either the up button or the down button.

Another implementation of the present disclosure includes a sensor device or thermostat for use in a room. The sensor device or thermostat includes a temperature sensor configured to sense temperature in the room, a humidity sensor configured to sense humidity in the room, a carbon dioxide sensor configured to sense the carbon dioxide level in the room, and a touch-sensitive display. The touch-sensitive display includes a fixed segment temperature icon associated with the temperature sensor, a number of fixed segment temperature value numerals located next to the fixed segment temperature icon, a fixed segment humidity icon associated with the humidity sensor, a number of fixed segment humidity value numerals located next to the fixed segment humidity icon, a fixed segment carbon dioxide icon associated with the carbon dioxide sensor, a number of fixed segment carbon dioxide numeral located next to the fixed segment carbon dioxide icon, a number of large fixed segment numerals, the number of large fixed segment numerals having a larger size than the fixed segment temperature value numerals, the fixed segment humidity value numerals, and the fixed segment carbon dioxide numerals. The touch-sensitive display further includes a number of touch sensitive buttons configured to receive a user input and a control circuit communicably coupled to the temperature sensor, the humidity sensor, the carbon dioxide sensor, and the display, wherein the control circuit is structured to, in a response to a user input selecting one of the temperature sensor, the humidity sensor, the carbon dioxide sensor, cause the number of fixed segment numerals to display a value associated with the selected sensor.

In some embodiments, the control circuit is further structured to, in response to a user input to display an environmental condition value, cause the second number of fixed segment numerals to display a value of the environmental condition sensed by the selected sensor. In some embodiments, the control circuit is further structured to, in response to a user input to display a set point value, cause the second number of numerals to display a set point for the environmental condition associated with the selected sensor. In some embodiments, the sensor device or thermostat further includes an occupancy sensor configured to sense the presence of a person in the room.

In some embodiments, the control circuit is configured to, in response to a user input selecting for display one of the fixed segment temperature icon, the fixed segment humidity icon, and the fixed segment carbon dioxide icon, cause the selected fixed segment icon and the associated number of fixed segment numerals to illuminate. In some embodiments, the control circuit is configured to, in response to a user input deselecting for display one of the fixed segment temperature icon, the fixed segment humidity icon, and the fixed segment carbon dioxide icon, cause the deselected fixed segment icon and the associated number of fixed segment numerals to darken.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with an HVAC system, according to an exemplary embodiment.

FIG. 2 is a block diagram of a waterside system that may be used in conjunction with the building of FIG. 1, according to an exemplary embodiment.

FIG. 3 is a block diagram of an airside system that may be used in conjunction with the building of FIG. 1, according to an exemplary embodiment.

FIG. 4 is a block diagram of a BMS system that may be used to control the HVAC system of FIG. 1, according to an exemplary embodiment.

FIG. 5 is a drawing of a cantilevered thermostat with a transparent display that may be used to control the HVAC system of FIG. 1, according to an exemplary embodiment.

FIG. 6 is a schematic drawing of a building equipped with a residential heating and cooling system and the thermostat of FIG. 5, according to an exemplary embodiment.

FIG. 7 is a schematic drawing of the thermostat and the residential heating and cooling system of FIG. 6, according to an exemplary embodiment.

FIG. 8 is a perspective view of a sensor device with a configurable display, according to an exemplary embodiment.

FIG. 9 is a front view of the configurable display of the device of FIG. 8, according to an exemplary embodiment.

FIG. 10 is a schematic drawing of the configurable display of FIG. 9, according to an exemplary embodiment.

FIG. 10A is a first display configuration of the interface of FIG. 10, according to an exemplary embodiment.

FIG. 10B is a is a second display configuration of the interface of FIG. 10, according to an exemplary embodiment.

FIG. 11 is a block diagram of the sensor device of FIG. 9, according to an exemplary embodiment.

FIG. 12 is a flow diagram of a process for editing parameters of the configurable display of FIG. 10, according to an exemplary embodiment.

FIG. 13 is a flow diagram of a process for configuring the configurable display of FIG. 10, according to an exemplary embodiment.

### DETAILED DESCRIPTION

### Overview

Referring generally to the FIGURES, systems and methods of a configurable display for sensor devices and/or thermostats are shown, according to various exemplary embodiments. In a building, various zones may be defined where environmental conditions of each zone are controlled by building equipment located in the zone or otherwise associated with the zone. For example, in the building, an air handler unit (AHU) may heat or cool air for the entire building. In each zone, an HVAC system can regulate the environmental conditions where a sensor device or thermostat can control the HVAC to heat or cool the zone.

The sensor device and/or thermostat can control the HVAC system by sending electrical signals to the system and/or opening and/or closing switches. A sensor device and/or thermostat can measure the environmental conditions of a zone (e.g., one or more rooms in the building) through one or more sensors and use the measurements to determine the deviation in the environmental conditions from a set point. The sensor device may also act as a local thermostat by receiving user input and determining control signals sent to the HVAC system. The set point of an environmental condition of a zone can be configured by a user through an interface. A sensor device and/or thermostat interface is typically a fixed segment touch screen display. Many unique parameters may exist for various environmental conditions. Simultaneous display of many unique parameters on a fixed segment display is difficult because each unique display element is fixed and requires space on the display. Conventional compact fixed segment displays cannot simultaneously display many unique parameters. Accordingly, a fixed segment display featuring many unique display elements may be large. A sensor device and/or thermostat may not fit a large display. Furthermore, as a facility may have a large number of sensor devices and/or thermostats, an expensive display, capable of displaying many unique elements in a smaller area, may not be practical from a cost perspective. Therefore, an affordable compact display, such as a fixed segment display, capable of simultaneously displaying many unique parameters may be desirable. A sensor device and/or thermostat with a configurable display may display many unique parameters simultaneously. A configurable display may change the presentation of parameters based on user configuration. For example, in an archival setting where high level of humidity may be harmful to the materials stored in the archive (e.g., books) humidity may be set as the primary display while temperature and set point are displayed ancillarily. Furthermore, a configurable display may allow for adjustment of multiple parameters from a single display layout or screen. For example, a temperature set point and a fan speed may be adjusted from a single display layout (i.e. without changing the layout or appearance of the display). Configuration of conventional fixed segment displays is difficult because the same display elements used for display of parameters must be used for configuration. As such, configuration of conventional fixed segment displays involves multiple display layouts. Accordingly, a configurable display capable of not only displaying many unique parameters simultaneously but also allowing adjustment of multiple parameters from a single display layout is desirable as it is easy to use and understand.

In some embodiments described herein, a sensor device and/or thermostat with a configurable display may interact with a remote override system to change the presentation or function of the configurable display. For example, a landlord may remotely override a set point of an environmental condition of a zone inhabited by a tenant. In some embodiments, a configurable display may selectively illuminate display parameters. For example, the configurable display may flash a set point parameter when the set point is under adjustment. In some embodiments, a configurable display may be used in conjunction with a wall-mounted sensor device and/or thermostat. In some instances, these electronic devices may enclose at least four sensor components. For example, a sensor device may include a temperature sensor, a humidity sensor, an occupancy sensor, and a CO₂ sensor. Accordingly, a configurable display may include a display for each the temperature sensor, humidity sensor, occupancy sensor, and CO₂ sensor.

### Building HVAC Systems and Building Management Systems

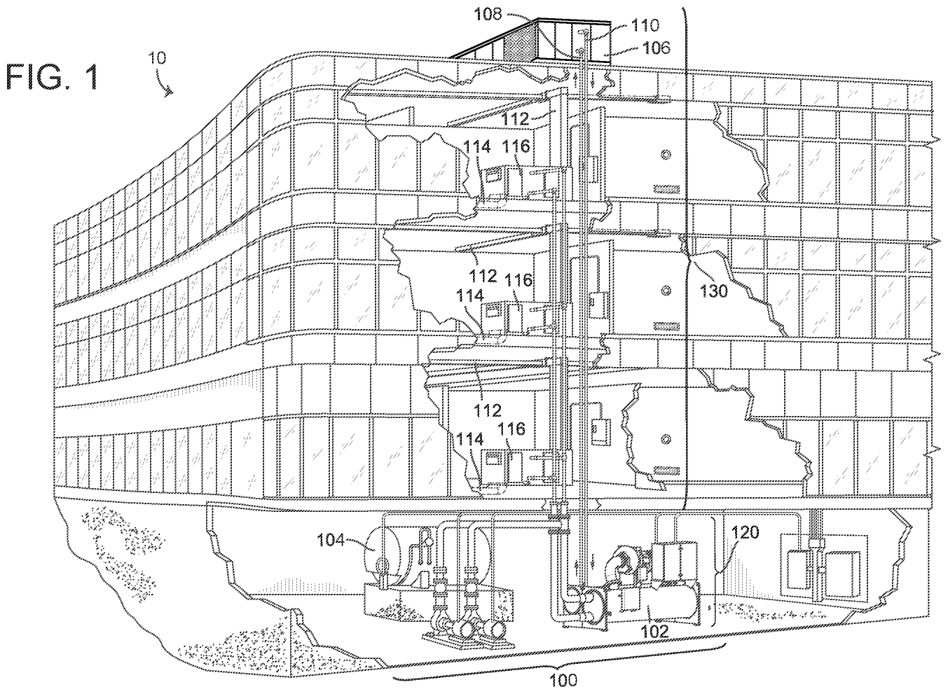

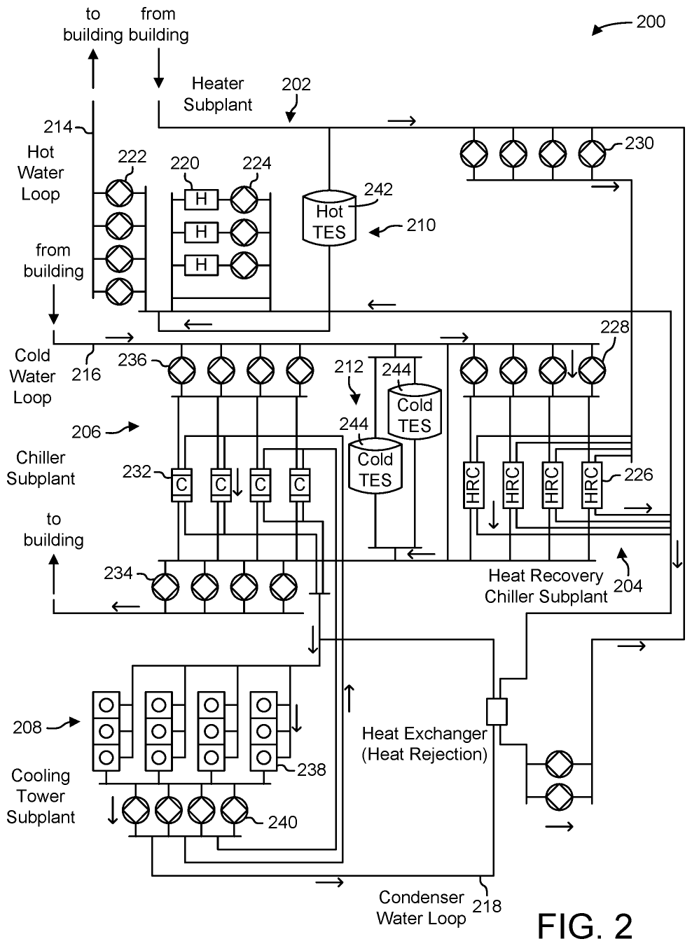

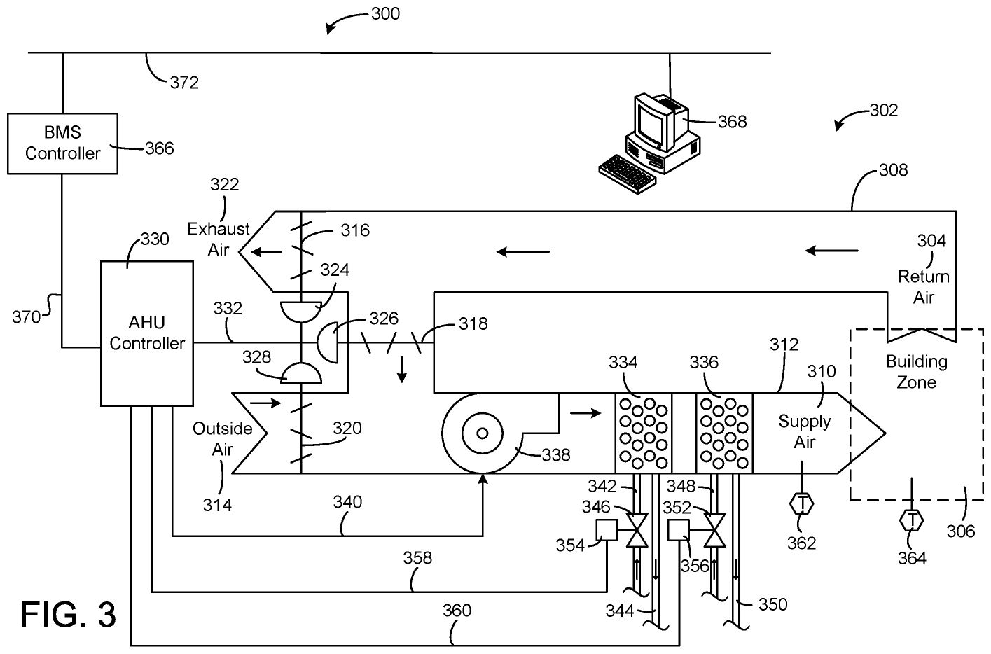

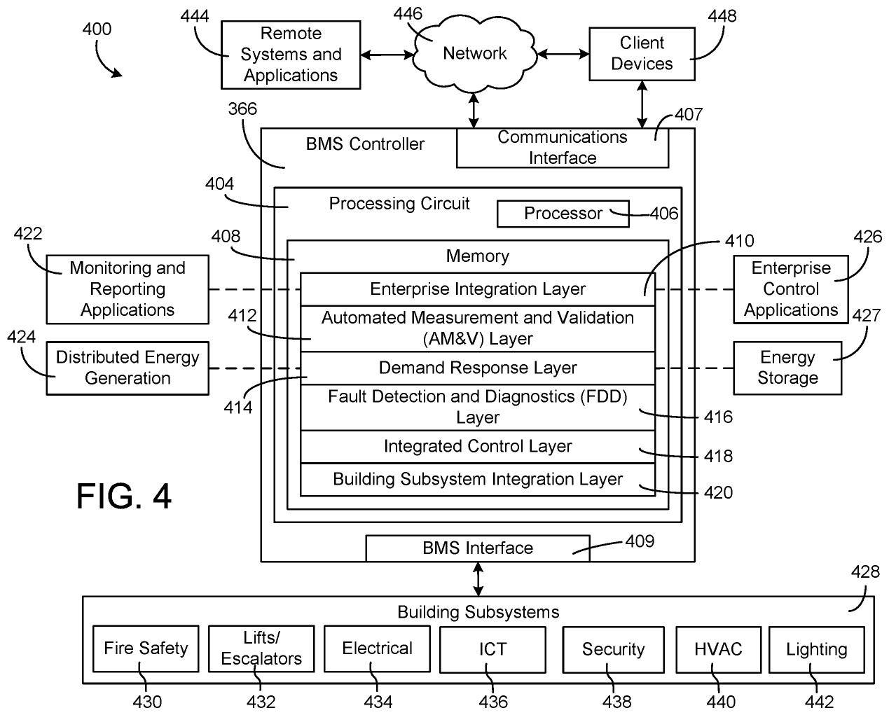

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

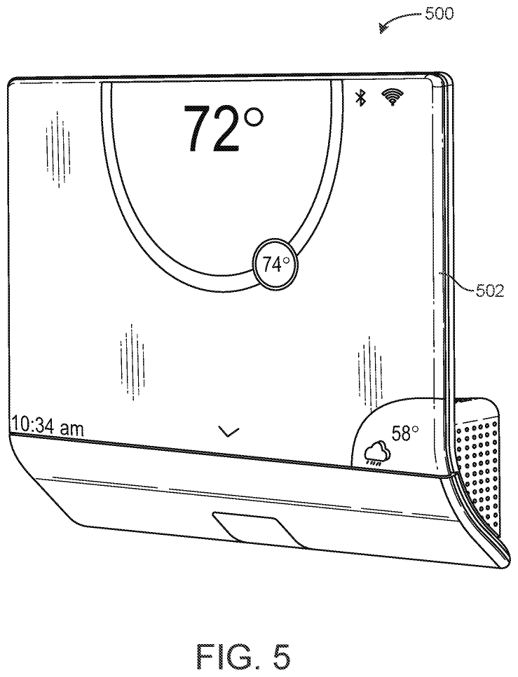

Referring now to FIG. 5, a drawing of a thermostat 500 for controlling building equipment is shown, according to an exemplary embodiment. The thermostat 500 is shown to include a display 502. The display 502 may be an interactive display that can display information to a user and receive input from the user. The display may be transparent such that a user can view information on the display and view the surface located behind the display. Thermostats with transparent and cantilevered displays are described in further detail in U.S. patent application Ser. No. 15/146,649 filed May 4, 2016, the entirety of which is incorporated by reference herein.

The display 502 can be a touchscreen or other type of electronic display configured to present information to a user in a visual format (e.g., as text, graphics, etc.) and receive input from a user (e.g., via a touch-sensitive panel). For example, the display 502 may include a touch-sensitive panel layered on top of an electronic visual display. A user can provide inputs through simple or multi-touch gestures by touching the display 502 with one or more fingers and/or with a stylus or pen. The display 502 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 502 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the display 402 is configured to present visual media (e.g., text, graphics, etc.) without requiring a backlight.

### Residential HVAC System

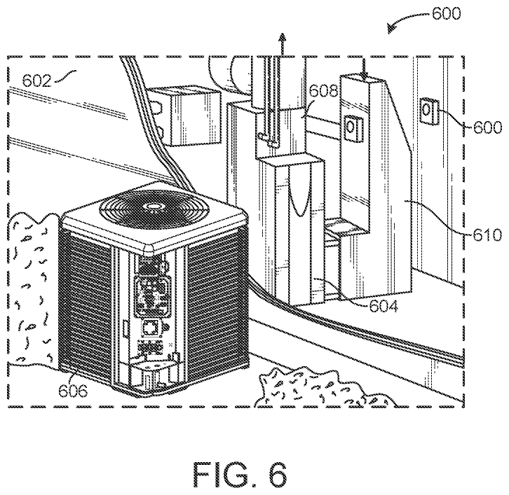

Referring now to FIG. 6, a residential heating and cooling system 600 is shown, according to an exemplary embodiment. The residential heating and cooling system 600 may provide heated and cooled air to a residential structure. Although described as a residential heating and cooling system 600, embodiments of the systems and methods described herein can be utilized in a cooling unit or a heating unit in a variety of applications include commercial HVAC units (e.g., roof top units). In general, a residence 602 includes refrigerant conduits that operatively couple an indoor unit 604 to an outdoor unit 606. Indoor unit 604 may be positioned in a utility space, an attic, a basement, and so forth. Outdoor unit 606 is situated adjacent to a side of residence 602. Refrigerant conduits transfer refrigerant between indoor unit 604 and outdoor unit 606, typically transferring primarily liquid refrigerant in one direction and primarily vaporized refrigerant in an opposite direction.

When the system 600 shown in FIG. 6 is operating as an air conditioner, a coil in outdoor unit 606 serves as a condenser for recondensing vaporized refrigerant flowing from indoor unit 604 to outdoor unit 606 via one of the refrigerant conduits. In these applications, a coil of the indoor unit 604, designated by the reference numeral 608, serves as an evaporator coil. Evaporator coil 608 receives liquid refrigerant (which may be expanded by an expansion device, not shown) and evaporates the refrigerant before returning it to outdoor unit 606.

Outdoor unit 606 draws in environmental air through its sides, forces the air through the outer unit coil using a fan, and expels the air. When operating as an air conditioner, the air is heated by the condenser coil within the outdoor unit 606 and exits the top of the unit at a temperature higher than it entered the sides. Air is blown over indoor coil 608 and is then circulated through residence 602 by means of ductwork 610, as indicated by the arrows entering and exiting ductwork 610. The overall system 600 operates to maintain a desired temperature as set by thermostat 500. When the temperature sensed inside the residence 602 is higher than the set point on the thermostat 500 (with the addition of a relatively small tolerance), the air conditioner will become operative to refrigerate additional air for circulation through the residence 602. When the temperature reaches the set point (with the removal of a relatively small tolerance), the unit can stop the refrigeration cycle temporarily.

In some embodiments, the system 600 configured so that the outdoor unit 606 is controlled to achieve a more elegant control over temperature and humidity within the residence 602. The outdoor unit 606 is controlled to operate components within the outdoor unit 606, and the system 600, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

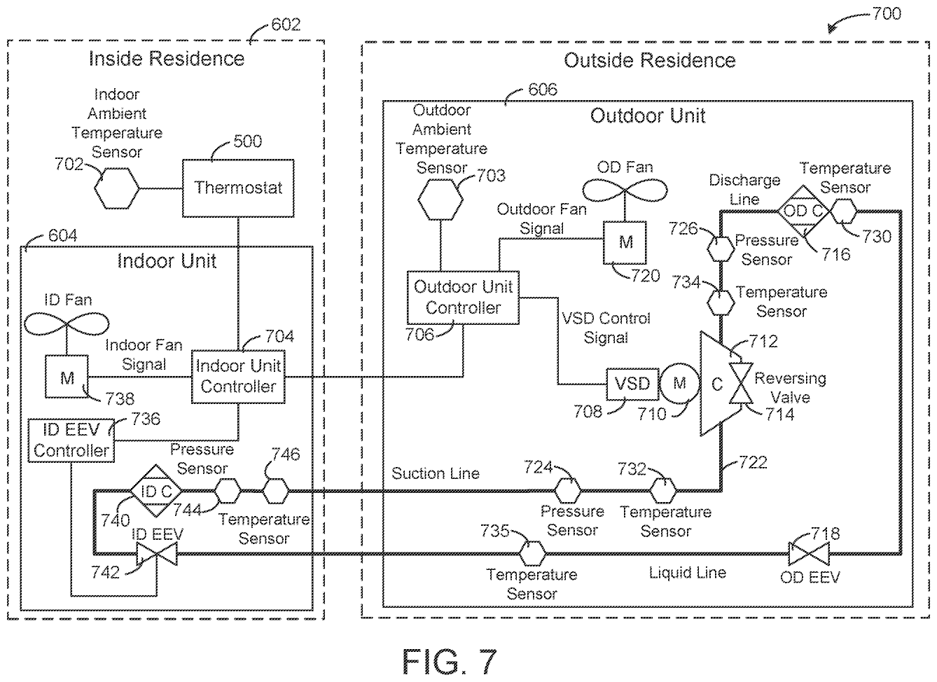

Referring now to FIG. 7, an HVAC system 700 is shown according to an exemplary embodiment. Various components of system 700 are located inside residence 602 while other components are located outside residence 602. Outdoor unit 606, as described with reference to FIG. 6, is shown to be located outside residence 602 while indoor unit 604 and thermostat 500, as described with reference to FIG. 6, are shown to be located inside the residence 602. In various embodiments, the thermostat 500 can cause the indoor unit 604 and the outdoor unit 606 to heat residence 602. In some embodiments, the thermostat 500 can cause the indoor unit 604 and the outdoor unit 606 to cool the residence 602. In other embodiments, the thermostat 500 can command an airflow change within the residence 602 to adjust the humidity within the residence 602.

Thermostat 500 can be configured to generate control signals for indoor unit 604 and/or outdoor unit 606. The thermostat 500 is shown to be connected to an indoor ambient temperature sensor 702, and an outdoor unit controller 706 is shown to be connected to an outdoor ambient temperature sensor 703. The indoor ambient temperature sensor 702 and the outdoor ambient temperature sensor 703 may be any kind of temperature sensor (e.g., thermistor, thermocouple, etc.). The thermostat 500 may measure the temperature of residence 602 via the indoor ambient temperature sensor 702. Further, the thermostat 500 can be configured to receive the temperature outside residence 602 via communication with the outdoor unit controller 706. In various embodiments, the thermostat 500 generates control signals for the indoor unit 604 and the outdoor unit 606 based on the indoor ambient temperature (e.g., measured via indoor ambient temperature sensor 702), the outdoor temperature (e.g., measured via the outdoor ambient temperature sensor 703), and/or a temperature set point.

The indoor unit 604 and the outdoor unit 606 may be electrically connected. Further, indoor unit 604 and outdoor unit 606 may be coupled via conduits 722. The outdoor unit 606 can be configured to compress refrigerant inside conduits 722 to either heat or cool the building based on the operating mode of the indoor unit 604 and the outdoor unit 606 (e.g., heat pump operation or air conditioning operation). The refrigerant inside conduits 722 may be any fluid that absorbs and extracts heat. For example, the refrigerant may be hydro fluorocarbon (HFC) based R-410A, R-407C, and/or R-134a.

The outdoor unit 606 is shown to include the outdoor unit controller 706, a variable speed drive 708, a motor 710 and a compressor 712. The outdoor unit 606 can be configured to control the compressor 712 and to further cause the compressor 712 to compress the refrigerant inside conduits 722. In this regard, the compressor 712 may be driven by the variable speed drive 708 and the motor 710. For example, the outdoor unit controller 706 can generate control signals for the variable speed drive 708. The variable speed drive 708 (e.g., an inverter, a variable frequency drive, etc.) may be an AC-AC inverter, a DC-AC inverter, and/or any other type of inverter. The variable speed drive 708 can be configured to vary the torque and/or speed of the motor 710 which in turn drives the speed and/or torque of compressor 712. The compressor 712 may be any suitable compressor such as a screw compressor, a reciprocating compressor, a rotary compressor, a swing link compressor, a scroll compressor, or a turbine compressor, etc.

In some embodiments, the outdoor unit controller 706 is configured to process data received from the thermostat 500 to determine operating values for components of the system 700, such as the compressor 712. In one embodiment, the outdoor unit controller 706 is configured to provide the determined operating values for the compressor 712 to the variable speed drive 708, which controls a speed of the compressor 712. The outdoor unit controller 706 is controlled to operate components within the outdoor unit 606, and the indoor unit 604, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

In some embodiments, the outdoor unit controller 706 can control a reversing valve 714 to operate system 700 as a heat pump or an air conditioner. For example, the outdoor unit controller 706 may cause reversing valve 714 to direct compressed refrigerant to the indoor coil 740 while in heat pump mode and to an outdoor coil 716 while in air conditioner mode. In this regard, the indoor coil 740 and the outdoor coil 716 can both act as condensers and evaporators depending on the operating mode (i.e., heat pump or air conditioner) of system 700.

Further, in various embodiments, outdoor unit controller 706 can be configured to control and/or receive data from an outdoor electronic expansion valve (EEV) 718. The outdoor electronic expansion valve 718 may be an expansion valve controlled by a stepper motor. In this regard, the outdoor unit controller 706 can be configured to generate a step signal (e.g., a PWM signal) for the outdoor electronic expansion valve 718. Based on the step signal, the outdoor electronic expansion valve 718 can be held fully open, fully closed, partial open, etc. In various embodiments, the outdoor unit controller 706 can be configured to generate a step signal for the outdoor electronic expansion valve 718 based on a subcool and/or superheat value calculated from various temperatures and pressures measured in system 700. In one embodiment, the outdoor unit controller 706 is configured to control the position of the outdoor electronic expansion valve 718 based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit controller 706 can be configured to control and/or power outdoor fan 720. The outdoor fan 720 can be configured to blow air over the outdoor coil 716. In this regard, the outdoor unit controller 706 can control the amount of air blowing over the outdoor coil 716 by generating control signals to control the speed and/or torque of outdoor fan 720. In some embodiments, the control signals are pulse wave modulated signals (PWM), analog voltage signals (i.e., varying the amplitude of a DC or AC signal), and/or any other type of signal. In one embodiment, the outdoor unit controller 706 can control an operating value of the outdoor fan 720, such as speed, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit 606 may include one or more temperature sensors and one or more pressure sensors. The temperature sensors and pressure sensors may be electrical connected (i.e., via wires, via wireless communication, etc.) to the outdoor unit controller 706. In this regard, the outdoor unit controller 706 can be configured to measure and store the temperatures and pressures of the refrigerant at various locations of the conduits 722. The pressure sensors may be any kind of transducer that can be configured to sense the pressure of the refrigerant in the conduits 722. The outdoor unit 606 is shown to include pressure sensor 724. The pressure sensor 724 may measure the pressure of the refrigerant in conduit 722 in the suction line (i.e., a predefined distance from the inlet of compressor 712). Further, the outdoor unit 606 is shown to include pressure sensor 726. The pressure sensor 726 may be configured to measure the pressure of the refrigerant in conduits 722 on the discharge line (e.g., a predefined distance from the outlet of compressor 712).

The temperature sensors of outdoor unit 606 may include thermistors, thermocouples, and/or any other temperature sensing device. The outdoor unit 606 is shown to include temperature sensor 730, temperature sensor 732, temperature sensor 734, and temperature sensor 736. The temperature sensors (i.e., temperature sensor 730, temperature sensor 732, temperature sensor 735, and/or temperature sensor 746) can be configured to measure the temperature of the refrigerant at various locations inside conduits 722.

Referring now to the indoor unit 604, the indoor unit 604 is shown to include indoor unit controller 704, indoor electronic expansion valve controller 736, an indoor fan 738, an indoor coil 740, an indoor electronic expansion valve 742, a pressure sensor 744, and a temperature sensor 746. The indoor unit controller 704 can be configured to generate control signals for indoor electronic expansion valve controller 742. The signals may be set points (e.g., temperature set point, pressure set point, superheat set point, subcool set point, step value set point, etc.). In this regard, indoor electronic expansion valve controller 736 can be configured to generate control signals for indoor electronic expansion valve 742. In various embodiments, indoor electronic expansion valve 742 may be the same type of valve as outdoor electronic expansion valve 718. In this regard, indoor electronic expansion valve controller 736 can be configured to generate a step control signal (e.g., a PWM wave) for controlling the stepper motor of the indoor electronic expansion valve 742. In this regard, indoor electronic expansion valve controller 736 can be configured to fully open, fully close, or partially close the indoor electronic expansion valve 742 based on the step signal.

Indoor unit controller 704 can be configured to control indoor fan 738. The indoor fan 738 can be configured to blow air over indoor coil 740. In this regard, the indoor unit controller 704 can control the amount of air blowing over the indoor coil 740 by generating control signals to control the speed and/or torque of the indoor fan 738. In some embodiments, the control signals are pulse wave modulated signals (PWM), analog voltage signals (i.e., varying the amplitude of a DC or AC signal), and/or any other type of signal. In one embodiment, the indoor unit controller 704 may receive a signal from the outdoor unit controller indicating one or more operating values, such as speed for the indoor fan 738. In one embodiment, the operating value associated with the indoor fan 738 is an airflow, such as cubic feet per minute (CFM). In one embodiment, the outdoor unit controller 706 may determine the operating value of the indoor fan based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The indoor unit controller 704 may be electrically connected (e.g., wired connection, wireless connection, etc.) to pressure sensor 744 and/or temperature sensor 746. In this regard, the indoor unit controller 704 can take pressure and/or temperature sensing measurements via pressure sensor 744 and/or temperature sensor 746. In one embodiment, pressure sensor 744 and temperature sensor 746 are located on the suction line (i.e., a predefined distance from indoor coil 740). In other embodiments, the pressure sensor 744 and/or the temperature sensor 746 may be located on the liquid line (i.e., a predefined distance from indoor coil 740).

Sensor Device with Configurable Display

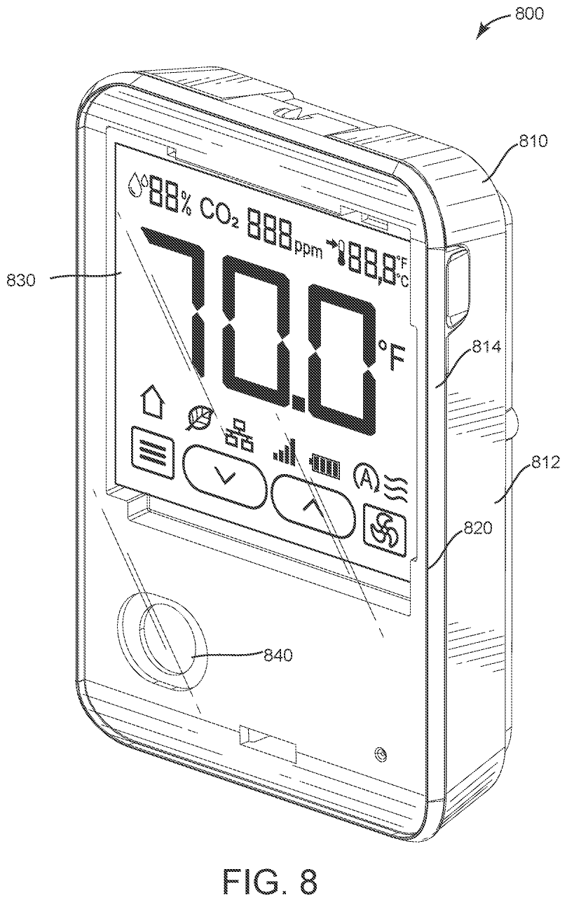

Referring now to FIG. 8, a sensor device 800 with a configurable display 830 is shown, according to an exemplary embodiment. In some embodiments, sensor device 800 may enclose at least four sensor components. Traditional sensor devices and/or thermostats support up to three sensor components. For example, a traditional sensor device might support a temperature sensor, a humidity sensor, and an occupancy sensor. However, previously conventional CO₂ sensors were too large to be enclosed in the same sensor housing with a temperature sensor, a humidity sensor, and an occupancy sensor and two separate sensor devices would need to be used for a room requiring all four sensor inputs. Accordingly, a sensor device 800 supporting at least four sensor components reduces the need for additional external sensor devices and/or thermostats. In addition, traditional sensor devices and/or thermostats support display of a single environmental parameter. For example, a traditional sensor device may display only temperature set point. Sensor device 800 may display multiple environmental parameters simultaneously as will be appreciated by one skilled in the art with reference below. For example, sensor device 800 may simultaneously display a temperature set point, a temperature measurement, a CO₂ concentration measurement, and a humidity level measurement.

Sensor device 800 may include a rear portion 810 including back plate 812 and bezel 814 and a front portion including faceplate 820. Back plate 812, bezel 814, and faceplate 820 may mate together to form a complete enclosure to encapsulate the components of sensor device 800. In some embodiments, these components may include one or more circuit card assemblies, control devices (e.g., actuators, buttons, etc.), and display screens. Faceplate 820 may be made of a clear or transparent material such that a display positioned behind faceplate 820 may be visible. In some embodiments, various ornamentations may be applied to the back surface of faceplate 820 such that the ornamentations remain visible but protected from abrasion or other external physical damage. For example, a brand logo could be applied to the back of faceplate 820. Different background colors could also be applied to the back of faceplate 820.

Sensor device 800 is shown to include display 830. Display 830 may be a configurable fixed segment display as described in greater detail below. Display 830 may be positioned within an opening of bezel 814 or faceplate 820 such that display 830 remains operable by a user. Display 830 may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, display 830 is configured to present visual media (e.g., text, graphics, etc.) without requiring a backlight.

In some embodiments, sensor device 800 includes occupancy sensor 840 configured to measure the occupancy of a space in which sensor device 800 is located. For example, a passive infrared sensor may be used as the occupancy sensor 840. Occupancy sensor 840 may be positioned in another location of sensor device 800. Bezel 812 and faceplate 820 may include a “window” or opening to allow occupancy sensor 840 to see through bezel 812 and faceplate 820 for the purpose of sensing occupancy.

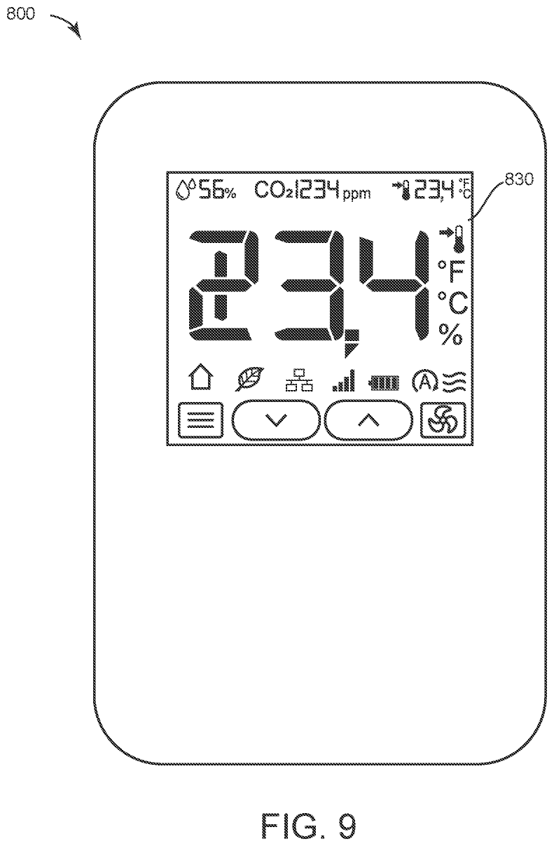

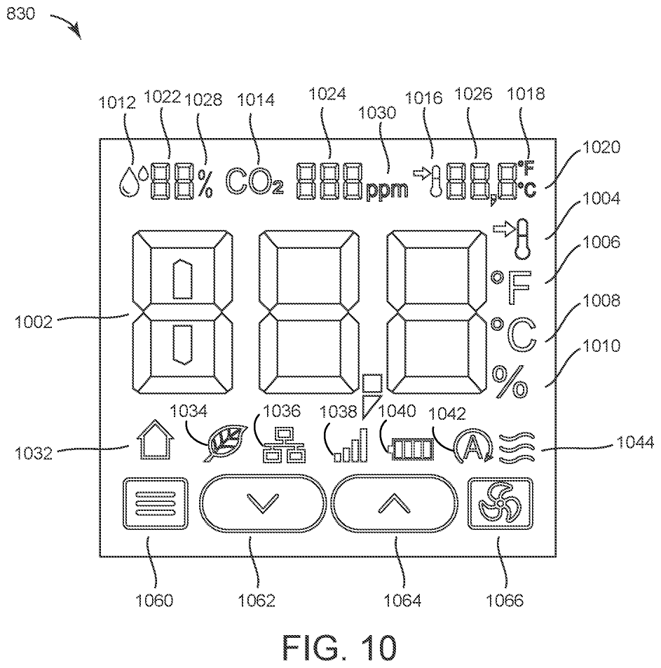

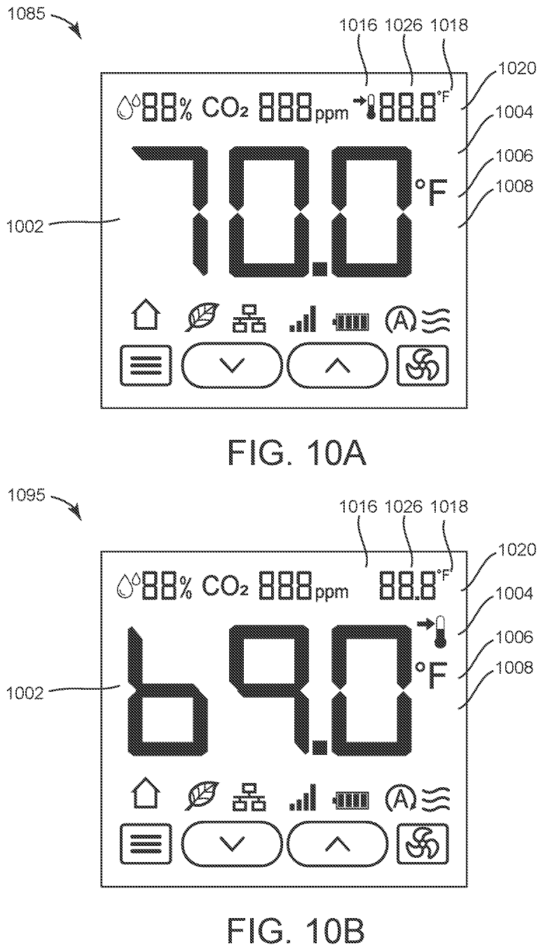

Turning now to FIG. 9, a front view of sensor device 800 focusing on display 830 is shown, according to an exemplary embodiment. Display 830 can be configured to present readings from a multitude of sensors simultaneously to a user as described below with reference to FIG. 10. A user may interact with display 830 to change a value of multiple environmental parameters from a single display layout as described in detail below. Configuration of display 830 and/or sensor device 800 may occur locally (i.e., using display 830) or remotely via a BMS system (e.g., BMS controller 366) and a variety of communication protocols (e.g., BACnet, IP, LON, etc.). In some embodiments, display 830 includes a backlight to illuminate display 830 for optimal viewing by a user.

In some embodiments, various sensor components (e.g., a temperature sensor, a humidity sensor, an occupancy sensor, a CO₂ sensor, a VoC sensor, a NO sensor, a NO₂ sensor, a CO sensor, a smoke sensor, etc.) may be added to or removed from sensor device 800. In some embodiments, display 830 may be configured to update to a different presentation or arrangement in response to a change in the number and/or type of sensor components installed with sensor device 800.

In some embodiments, display 830 can be a touchscreen or other type of electronic display configured to present information to a user in a visual format (e.g., as text, graphics, etc.) and receive input from a user (e.g., via a touch-sensitive panel). For example, display 830 may include a touch-sensitive panel layered on top of an electronic visual display. A user can provide inputs through simple or multi-touch gestures by touching the display 830 with one or more fingers and/or with a stylus or pen. Display 830 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 830 allowing registration of touch in two or even more locations at once.

Referring now to FIG. 10, a schematic drawing of display 830 is shown, according to an exemplary embodiment. Display 830 can include fixed segment numerals 1002. Fixed segment numerals 1002 may selectively illuminate to display a primary parameter value. Fixed segment numerals 1002 may be configured to be of a large font or otherwise highly visible to a user at a distance away from sensor device 800.

Display 830 may include primary set point icon 1004, primary Fahrenheit icon 1006, primary Celsius icon 1008, and primary humidity icon 1010 abutting fixed segment numerals 1002. One of primary set point icon 1004, primary Fahrenheit icon 1006, primary Celsius icon 1008, or primary humidity icon 1010 may illuminate to indicate an environmental condition associated with fixed segment numerals 1002. For example, a set point of 70° F. may be represented by illuminating a 70 with fixed segment numerals 1002 and illuminating primary set point icon 1010.

Display may include secondary humidity icon 1012, secondary CO₂ icon 1014, secondary set point icon 1016, secondary Fahrenheit icon 1018, and secondary Celsius icon 1020 positioned above fixed segment numerals 1002. Display may further include humidity value numerals 1022, CO₂ value numerals 1024, and temperature value numerals 1026 and humidity unit icon 1028 and CO₂ unit icon 1030 abutting icons 1012-1020, respectively. Numerals 1022-1026 may selectively illuminate to simultaneously display the value of one or more environmental conditions concurrent to fixed segment display 1002. Furthermore, icons 1012-1020 may illuminate to indicate an environmental condition associated with numerals 1022-1026. Unit icons 1028-1030 may also illuminate to indicate a unit of measurement associated with the value displayed by numerals 1022-1026. For example, a humidity of 80%, a CO₂ concentration of 200 parts per million, and a temperature of 24° C. may be represented by illuminating an 80 with humidity value numerals 1022, illuminating a 200 with CO₂ value numerals 1022, illuminating a 24 with temperature value numerals 1026, and illuminating each of humidity icon 1012, humidity unit icon 1028, CO₂ icon 1014, CO₂ unit icon 1030, and secondary Celsius icon 1020.

Icons 1012-1020, numerals 1022-1026, and unit icons 1028-1030 can be configured to be smaller than fixed segment numerals 1002 and icons 1004-1010, respectively. In some embodiments, a different number, type, and/or combination of environmental conditions may be represented by icons 1012-1020, numerals 1022-1026, and unit icons 1028-1030. In some embodiments, a user may interact with sensor device 800 to configure display 830 to display a parameter (e.g., temperature set point, measured temperature, humidity, etc.) as the primary display (using fixed segment numerals 1002 and one of icons 1004-1010). For example, a user could select temperature set point as the primary display (displayed using fixed segment numerals 1002 and primary set point icon 1002) and humidity, CO₂ concentration, and measured temperature as secondary display values (displayed via icons 1012-1020, numerals 1022-1026, and unit icons 1028-1030 as discussed above).

Display 830 may also include occupancy status icon 1032, eco-mode status icon 1034, system connection status icon 1036, network connection status icon 1038, battery status icon 1040, air recycling status icon 1042, and fan status icon 1044 below fixed segment numerals 1002. Occupancy status icon 1032 may display the occupancy status of the space sensor device 800 is located in by illuminating to indicate occupancy and darkening to indicate vacancy. For example, occupancy status icon 1032 may be illuminated in response to occupancy sensor 840 determining the presence of a user in the space sensor device 800 is located in. Eco-mode status icon 1034 may display the operation of an “economy” mode of an HVAC system (e.g., HVAC system 100) by illuminating to indicate an economy mode is enabled and darkening to indicate an economy mode is disabled.

System connection status icon 1036 may display the connection status of sensor device 800 to a HVAC system (e.g., HVAC system 100) or a BMS system (e.g., BMS controller 366) by illuminating to indicate connection and darkening to indicate no connection. System connection status icon 1036 may blink to indicate a connection error or other connection failure. Network connection status icon 1038 may display the network connection status of sensor device 800 by selectively illuminating to indicate connection and darkening to indicate no connection. For example, a single small bar of network connection status icon 1038 may illuminate to show weak connection, all four bars of network connection status icon 1038 may illuminate to show strong connection, and all four bars of network connection status icon 1038 may darken to show no connection. Battery status icon 1040 may display the battery status of the sensor device 800 by sequentially illuminating to indicate full battery charge and darkening to indicate empty battery charge. For example, a leftmost rectangle of battery status icon 1040 may illuminate to show low battery charge, all four rectangles of battery status icon 1040 may illuminate to show full battery charge, and all four rectangles of battery status icon 1040 may darken to show empty battery charge.

Air recycling status icon 1042 may display the air recycling status of a HVAC system (e.g., HVAC system 100) by illuminating to show air recycling and darkening to show no air recycling. Fan status icon 1044 may display the fan status of a HVAC system (e.g., HVAC system 100) by sequentially illuminating to show fan operation and darkening to show fan idle. For example, a bottommost tilde of fan status icon 1044 may illuminate to show low fan speed, all three tildes of fan status icon 1044 may illuminate to show high fan speed, and all three tildes of fan status icon 1044 may darken to show fan idle.

Status icons 1032-1044 can display the status of various components of an HVAC system (e.g., HVAC system 100) by illuminating, flashing, or any other means. For example, system connection icon 1036 may flash to show a system connection error. Status icons 1032-1044 may include different icons for different system statuses or a different combination or arrangement of status icons 1032-1044 thereof. In some embodiments, status icons 1032-1044 are touch selectable to generate further action. For example, a user may touch flashing system connection status icon 1036 to produce a diagnostic dialog describing a connection error. In some embodiments, a user can configure display 830 to hide status icons 1032-1044.

Display 830 can include menu icon 1060, down icon 1062, up icon 1064, and fan icon 1066. Icons 1060-1066 may be used by a user to interact with sensor device 800. For example, a user may use icons 1060-1066 to configure display 830 as described in detail below. Menu icon 1060 may be selected to open a menu dialog to allow for local configuration of sensor device 800 as described in detail below. Down icon 1062 may be selected to provide input to sensor device 800. For example, a user may select down icon 1062 to decrease a temperature set point displayed as the primary display by one degree (e.g., 70° F. to 69° F.). Up icon 1064 may be selected to further provide input to sensor device 800. For example, a user may select up icon 1064 to increase a temperature set point displayed as the primary display by one degree (e.g., 69° F. to 70° F.). In some embodiments, down icon 1062 and up icon 1064 may be used in combination (i.e. selected simultaneously) to generate further action. For example, a user may select down icon 1062 and up icon 1064 simultaneously to open a configuration dialog to allow for local configuration of sensor device 800 as described in detail below.

In some embodiments, fan icon 1066 may be selected to modify operation of a fan of a HVAC system (e.g., HVAC system 100). For example, a user may select fan icon 1066 to generate a control signal for a HVAC system (e.g., HVAC system 100) to change a fan level from “low” to “medium.” In some embodiments, fan status icon 1044 may update concomitantly with selection of fan icon 1066. For example, a user selection of fan icon 1066 may change display of fan status icon 1044 from a single tilde to two tildes to represent an increase in fan speed operation.

In some embodiments, interaction with various elements of display 830 (e.g., fixed segment numerals 1002, icons 1004-1010, icons 1012-1020, icons 1060-1066, etc.) may provide haptic or auditory feedback to a user. For example, user selection of down icon 1062 may cause sensor device 800 to vibrate and/or produce a “beep” sound.

In some embodiments, various elements of display 830 (e.g., fixed segment numerals 1002, icons 1004-1010, icons 1012-1020, icons 1060-1066, etc.) may have a different arrangement, appearance, size, placement, or may otherwise be varied. The appearance of display 830 may be configured by a user as described in detail below. For example, a user may use icons 1060-1064 to change a temperature representation from degrees Fahrenheit to degrees Celsius. In some embodiments, display 830 may alter the appearance of a display parameter to indicate the fidelity of the parameter. For example, display 830 may flash a temperature measurement to indicate that the temperature measurement may be faulty due to an error with a temperature sensor providing the measurement.

Turning now to FIGS. 10A and 10B, two exemplary configurations of display 830 are shown. FIG. 10A shows a temperature measurement configuration 1085 and FIG. 10B shows a temperature set point configuration 1095. Display 830 may have many other configurations. Display 830 may be configured to change between configurations (e.g., temperature measurement configuration 1085, temperature set point configuration 1095, etc.) through a configuration process described in detail below.

Temperature measurement configuration 1085 may display a temperature measurement from a temperature sensor as a primary display parameter using fixed segment numerals 1002. For example, temperature measurement configuration 1085 may display the ambient temperature of the space sensor device 800 is located in, as sensed by a temperature sensor of sensor device 800, as a primary display parameter. Display 830 may indicate that the value represented by fixed segment numerals 1002 corresponds to a temperature measurement by illuminating one of primary Fahrenheit icon 1006 or primary Celsius icon 1008 and darkening primary set point icon 1004 and primary humidity icon 1010. A temperature measurement displayed in degrees Fahrenheit may illuminate primary Fahrenheit icon 1006 and simultaneously darken primary Celsius icon 1008.

Still referring to FIG. 10A, temperature measurement configuration 1085 is shown to display a temperature set point parameter as a secondary display parameter. Temperature measurement configuration 1085 may display a temperature set point by illuminating secondary set point icon 1016 and displaying a temperature set point via temperature value numerals 1026. Additionally, display 830 may illuminate secondary Fahrenheit icon 1018 or secondary Celsius icon 1020 in accordance with primary Fahrenheit icon 1006 and primary Celsius icon 1008. For example, sensor device 830 configured by a user to operate in degrees Fahrenheit may illuminate primary Fahrenheit icon 1006 and secondary Fahrenheit icon 1018 and darken secondary Celsius icon 1020 and primary Celsius icon 1008. As will be appreciated by those skilled in the art, temperature measurement configuration 1085 allows for simultaneous display of a number of environmental condition parameters (i.e., humidity, CO₂ concentration, temperature, and temperature set point) and reduces a need to scroll through additional displays to view additional environmental condition parameters as is conventionally required.

Referring now specifically to FIG. 10B, temperature set point configuration 1095 may display a temperature set point for a HVAC system (e.g., HVAC system 100) as a primary display parameter using fixed segment numerals 1002. Display 830 may indicate that the value represented by fixed segment numerals 1002 corresponds to a temperature set point by illuminating primary set point icon 1004 and one of primary Fahrenheit icon 1006 or primary Celsius icon 1008 and primary humidity icon 1010. Temperature set point configuration 1095 may display a temperature measurement as a secondary display parameter in a similar manner as described above.

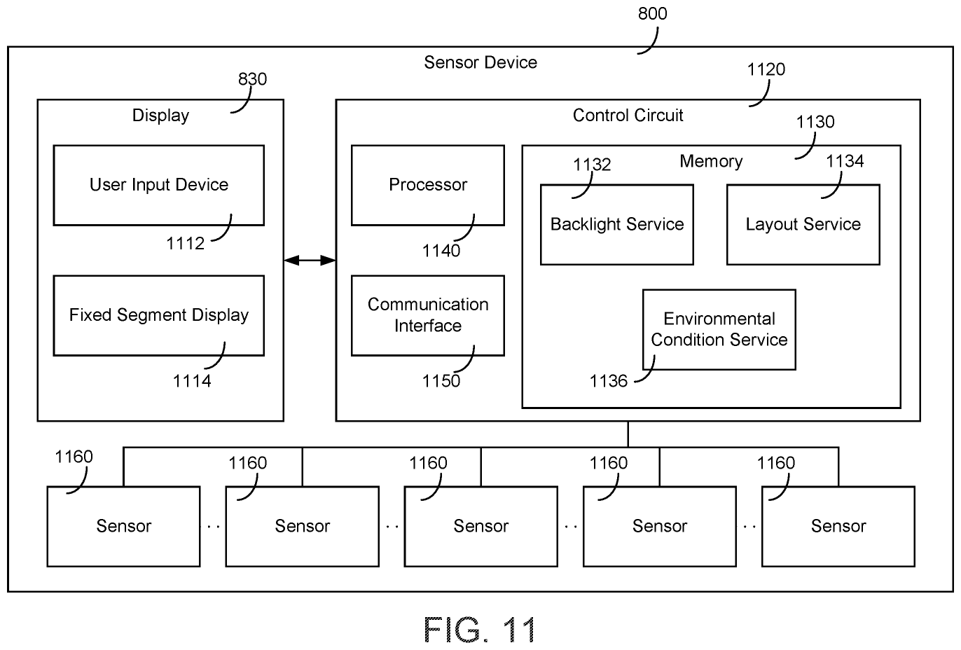

Turning now to FIG. 11, a block diagram of sensor device 800 is shown, according to an exemplary embodiment. Sensor device 800 may generate control signals for a HVAC system (e.g., HVAC system 100), may simultaneously display many unique environmental parameters, and may allow adjustment of multiple parameters from a single display layout. Sensor device 800 may include display 830, control circuit 1120, and a plurality of sensors 1160.

Display 830 may simultaneously display many unique environmental parameters and allow a user to interact with sensor device 800 as described in detail above. Display 830 can be a touchscreen or other type of electronic display configured to present information to a user in a visual format (e.g., as text, graphics, etc.) and receive input from a user (e.g., via a touch-sensitive panel). For example, display 830 may include a touch-sensitive panel layered on top of an electronic visual display. A user can provide inputs through simple or multi-touch gestures by touching the display 830 with one or more fingers and/or with a stylus or pen. Display 830 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 830 allowing registration of touch in two or even more locations at once.

Display 830 may include user input device 1112 and fixed segment display 1114. User input device 1112 may receive input from a user to generate control signals for sensor device 800. User input device 1112 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art.

Fixed segment display 1114 may present information to a user in a visual format. Fixed segment display 1114 may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, fixed segment display 1114 is configured to present visual media (e.g., text, graphics, etc.) without requiring a backlight.

Control circuit 1120 may be configured to receive input from sensors 1160, generate control signals, and control display 830. Control circuit 1120 can include memory 1130, processor 1140, and communications interface 1150. Control circuit 1120 can be communicably connected a HVAC system (e.g., HVAC system 100) or BMS system (e.g., BMS controller 366) via communication interface 1150 such that control circuit 1120 and the various components thereof can send and receive data. Processor 1140 can be implemented as a general purpose processor, an application specific integrated circuit (ASIC), one or more field programmable gate arrays (FPGAs), a group of processing components, or other suitable electronic processing components.

Communication interface 1150 can communicatively couple sensor device 800 with other devices (e.g., servers, systems, etc.) and allow for the exchange of information between sensor device 800 and other devices or systems. In some embodiments, communication interface 1150 communicatively couples the devices, systems, and servers of sensor device 800. In some embodiments, communication interface 1150 is at least one of and/or a combination of a Wi-Fi network, a wired Ethernet network, a Zigbee network, a Bluetooth network, and/or any other wireless network. Communication interface 1150 may be a local area network and/or a wide area network (e.g., the Internet, a building WAN, etc.) and may use a variety of communications protocols (e.g., BACnet, IP, LON, etc.). Communication interface 1150 may include routers, modems, and/or network switches. Communication interface 1150 may be a combination of wired and wireless networks.

Memory 1130 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1130 can be or include volatile memory or non-volatile memory. Memory 1130 can include database components, object code components, script components, or any other type of information structure for supporting the various activities and information structures described in the present application. According to some embodiments, memory 1130 is communicably connected to processor 1140 via control circuit 1120 and includes computer code for executing (e.g., by control circuit 1120 and/or processor 1140) one or more processes described herein.

Memory 1130 may include backlight service 1132, layout service 1134, and environmental condition service 1136. Backlight service 1132 may turn on or turn off a backlight of display 830 to allow display 830 to be easily viewed by a user from a distance. For example, backlight service 1132 may turn on a backlight of display 830 when a user interacts with display 830. Backlight service 1132 may use a Boolean description to determine the operation of a backlight. An example of a Boolean description which can be evaluated by backlight service 1132 is as follows:

BL=A+B+CD

where A can be a “backlight enabled” setting of sensor device 800, C can be a sensed occupancy, D can be a “occupancy backlight enabled” setting of sensor device 800, and B can be a “timeout” function. A may be a variable set by a user of sensor device 800 or may be a default value to determine an enabled or disabled state of a backlight of display 830. C may be a result of an occupancy sensor (e.g., occupancy sensor 840) and may evaluate to true if an occupancy sensor determines a space is occupied. D may be a variable set by a user of sensor device 800 or a default value to determine operation of a backlight in conjunction with an occupancy sensor (e.g., occupancy sensor 840). Backlight service 1132 may illuminate a backlight of display 830 if BL evaluates to true. An example of a timeout function which can be evaluated in conjunction with the example Boolean description above is as follow:

B=1≥[n−(seconds from last user interaction)]

where n is an integer and seconds from last user interaction is an integer. In some embodiments, n is a variable set by a user of sensor device 800 or is a default value. seconds from last user interaction is the number of second from when a user last interacted with sensor device 800. For example, if a user has not touched display 830 in 21 seconds then seconds from last user interaction would equal 21. B may evaluate to true if seconds from last user interaction is strictly less than n.

Layout service 1134 receives input from a user and configures the layout and display of display 830 as described in detail below. For example, layout service 1134 may receive user input to change a temperature value from displaying in degrees Fahrenheit to displaying in degrees Celsius. Environmental condition service 1136 receives user input to change an environmental condition parameter displayed on display 830 as described in detail below. For example, a user may select up icon 1064 to cause environmental condition service 1136 to increase the temperature set point displayed as a primary parameter by one degree Fahrenheit.

Sensors 1160 can be any number and/or type of sensors as described above or known in the art. For example, sensors 1160 may include an occupancy sensor, a smoke detection sensor, a VoC sensor, a temperature sensor, a CO₂ concentration sensor, a humidity sensor, or a CO sensor. In some embodiments, sensors 1160 include occupancy sensor 840 as described with reference to FIG. 8.

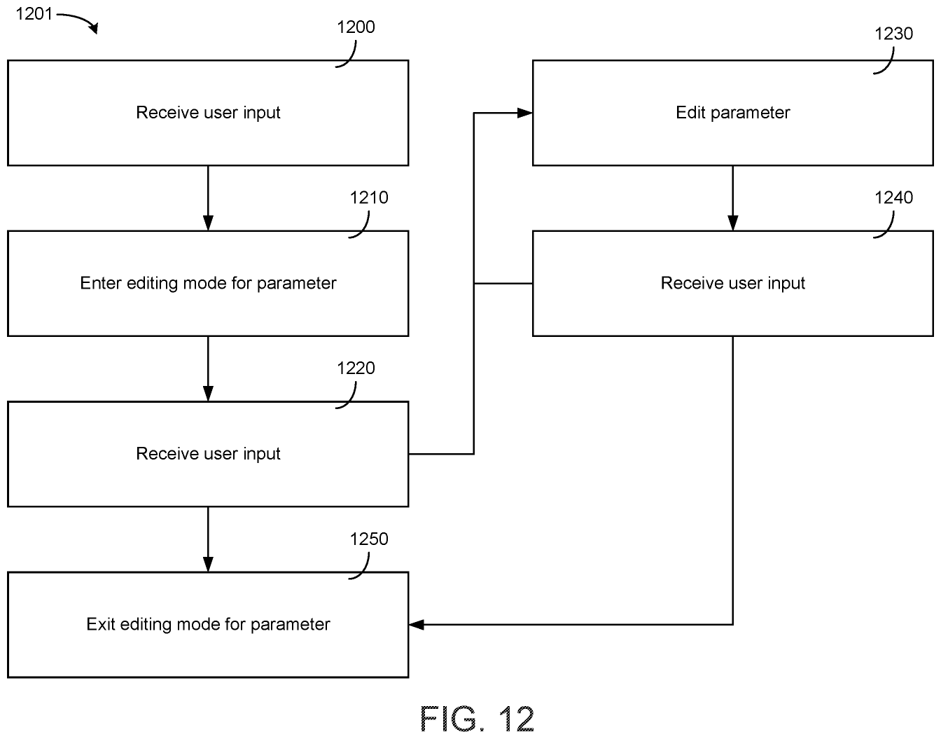

Referring now to FIG. 12, a flow diagram for a process 1201 of editing parameters of display 800 is shown, according to an exemplary embodiment. Process 1201 may be performed by environmental condition service 1136. Process 1201 may be used to edit parameters of display 800 and generate control signals for a HVAC system (e.g., HVAC system 100). For example, process 1201 may increase a temperature set point displayed as a primary parameter on display 830 from 69 degrees Fahrenheit to 70 degrees Fahrenheit.

At step 1200, sensor device 800 receives user input. User input may take the form of one or more selections of various elements of display 830 (e.g., fixed segment numerals 1002, icons 1004-1010, icons 1012-1020, icons 1060-1066, etc.) or may be an external signal sent from a BMS system (e.g., BMS controller 366). User input may select a specific parameter or may be a general user input. For example, user input can be a selection of humidity value numerals 1022 or may be selection of up icon 1064 respectively.

At step 1210, sensor device 800 enters an editing mode for a parameter. In some embodiments, the parameter being edited flashes while sensor device 800 is in the editing mode to indicate that the parameter is under adjustment. In some embodiments, the parameter being edited is determined at step 1200. For example, if a user selects humidity value numerals 1022 then step 1210 edits a humidity value, however if a user selects up icon 1064 then step 1210 edits whatever parameter is currently the primary display parameter (i.e. displayed by fixed segment numerals 1002).

At step 1220, sensor device 800 receives user input. In some embodiments, step 1220 selectively determines execution of step 1250 or step 1230. For example, a user selection of menu icon 1060 can trigger step 1250 while a user selection of up icon 1064 can trigger step 1230. At step 1230, sensor device 800 may generate a control signal for a BMS system (e.g., BMS controller 366) and change display of the parameter under adjustment. For example, if a temperature set point is under adjustment and a user selects up icon 1064, then sensor device 800 may increase a temperature set point parameter by one degree Fahrenheit. Adjustment of parameters at step 1230 may vary according to the specific parameter and configuration of sensor device 800. For example, editing a fan speed parameter may change a fan speed from “low” to “medium” while editing a temperature set point parameter may change a temperature set point from 22 degrees Celsius to 22.5 degrees Celsius.

At step 1240, editing via step 1230 continues until sensor device 800 receives user input to trigger step 1250 and exit editing mode for the parameter. For example, a user may select menu icon 1060 to trigger step 1250 from step 1240. At step 1250, sensor device 800 exits the editing mode. In some embodiments, the parameter having been edited stops flashing. In some embodiments, a timeout may trigger step 1250 directly. For example, while at step 1230, if a user fails to interact with sensor device 800 for a set period of time then sensor device 800 will automatically exit an editing mode for the parameter.

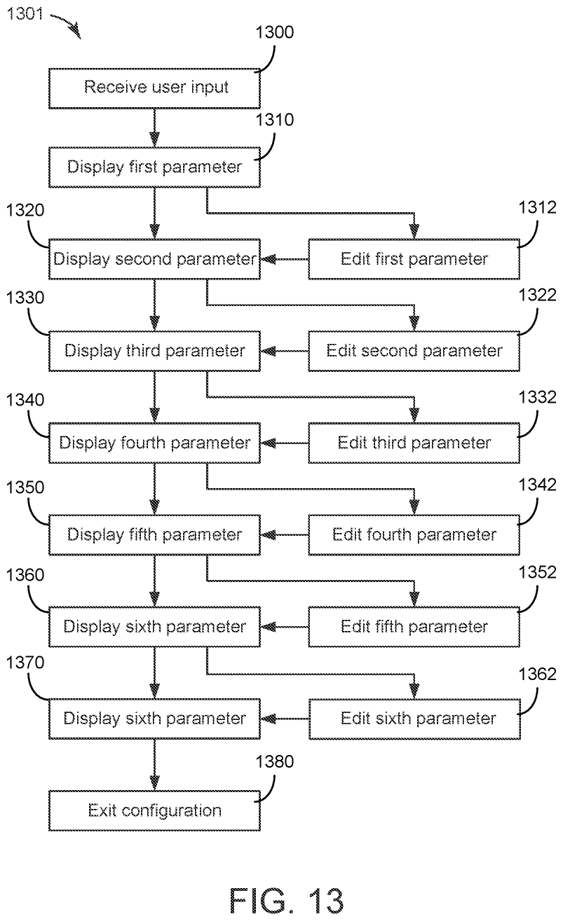

Referring now to FIG. 13, a flow diagram for a process 1301 of configuring display 800 is shown, according to an exemplary embodiment. Process 1301 may be performed by layout service 1134. Process 1301 may be used to configure display 800. For example, process 1301 may change a primary display parameter from a temperature measurement to a humidity measurement, may change display of temperatures from degrees Fahrenheit to degrees Celsius, or may change which various elements of display 830 (e.g., fixed segment numerals 1002, icons 1004-1010, icons 1012-1020, icons 1060-1066, etc.) are displayed. In some embodiments, process 1301 is completed locally by a user (with use of display 830 for example) or remotely via control signals from a BMS system (e.g., BMS controller 366).

At step 1300, sensor device 800 receives user input. User input may take the form of one or more selections of various elements of display 830 (e.g., fixed segment numerals 1002, icons 1004-1010, icons 1012-1020, icons 1060-1066, etc.) or may be an external signal sent from a BMS system (e.g., BMS controller 366). In some embodiments user input is a simultaneous selection of down icon 1062 and up icon 1064. In some embodiments, timings are associated with user input. For example, selection of down icon 1062 and up icon 1064 for a specified amount of time.

At step 1310, sensor device 800 displays a first configuration parameter. In some embodiments, the first configuration parameter is temperature units. Display 830 may flash or selectively illuminate one or more of secondary Fahrenheit icon 1018, secondary Celsius icon 1020, primary Fahrenheit icon 1006, or primary Celsius icon 1008 to indicate a configuration mode. In some embodiments, a first selection of up icon 1062 or down icon 1064 may be used to trigger step 1312 and a second selection of up icon 1062 or down icon 1064 may be used to toggle between display in degrees Fahrenheit and display in degrees Celsius. In some embodiments, selection of menu icon 1060 triggers step 1320.

At step 1320, sensor device 800 displays a second configuration parameter. In some embodiments, the second configuration parameter is a settings configuration. Display 830 may flash or selectively illuminate one or more of various elements of display 830 (e.g., fixed segment numerals 1002, icons 1004-1010, icons 1012-1020, icons 1060-1066, etc.) to indicate a configuration mode. In some embodiments, a first selection of up icon 1062 or down icon 1064 may be used to trigger step 1322 and a second selection of up icon 1062 or down icon 1064 may be used to toggle between default display setups. In some embodiments, selection of menu icon 1060 triggers step 1330.

At step 1330, sensor device 800 displays a third configuration parameter. In some embodiments, the third configuration parameter is an upper right display. Display 830 may flash or selectively illuminate one or more of fixed segment numerals 1002, temperature value numerals 1026, secondary set point icon 1016, or icons 1018-1020 to indicate a configuration mode. In some embodiments, a first selection of up icon 1062 or down icon 1064 may be used to trigger step 1332 and a second selection of up icon 1062 or down icon 1064 may be used to toggle between upper right setups. In some embodiments, selection of menu icon 1060 triggers step 1340.

At step 1340, sensor device 800 displays a fourth configuration parameter. In some embodiments, the fourth configuration parameter is a fan speed display. Display 830 may flash or selectively illuminate one or more of icons 1042-1044 or fan icon 1066 to indicate a configuration mode. In some embodiments, a first selection of up icon 1062 or down icon 1064 may be used to trigger step 1342 and a second selection of up icon 1062 or down icon 1064 may be used to toggle between fan speed setups. In some embodiments, selection of menu icon 1060 triggers step 1350.

At step 1350, sensor device 800 displays a fifth configuration parameter. In some embodiments, the fifth configuration parameter is a delimiter display. Display 830 may flash or selectively illuminate one or more of various elements of display 830 (e.g., fixed segment numerals 1002, icons 1004-1010, icons 1012-1020, icons 1060-1066, etc.) to indicate a configuration mode. In some embodiments, a first selection of up icon 1062 or down icon 1064 may be used to trigger step 1352 and a second selection of up icon 1062 or down icon 1064 may be used to toggle between delimiter setups. In some embodiments, selection of menu icon 1060 triggers step 1360.

At step 1360, sensor device 800 displays a sixth configuration parameter. In some embodiments, the sixth configuration parameter is an icon hide display. Display 830 may flash or selectively illuminate one or more of various elements of display 830 (e.g., fixed segment numerals 1002, icons 1004-1010, icons 1012-1020, icons 1060-1066, etc.) to indicate a configuration mode. In some embodiments, a first selection of up icon 1062 or down icon 1064 may be used to trigger step 1362 and a second selection of up icon 1062 or down icon 1064 may be used to toggle hidden and unhidden ones of various elements of display 830 (e.g., fixed segment numerals 1002, icons 1004-1010, icons 1012-1020, icons 1060-1066, etc.). In some embodiments, selection of menu icon 1060 triggers step 1370.

At step 1360, sensor device 800 displays a sixth configuration parameter as described above. In some embodiments, selection of menu icon 1060 triggers step 1380. At step 1380, sensor device 800 exits configuration and returns to normal operation. In some embodiments, a time out triggers step 1380. For example, while at step 1340 if a use fails to interact with sensor device 800 for a set period of time, step 1380 may be triggered and sensor device 800 may return to normal operation.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A sensor device for use in a building zone, comprising:
a plurality of sensor components, each sensor component configured to sense an environmental condition in the building zone;
a display including:
a first plurality of fixed segment icons, each fixed segment icon associated with one of the sensor components;
a first plurality of fixed segment numerals, each numeral associated with one of the fixed segment icons to display a value associated with a sensor component;
a second plurality of fixed segment numerals, the second plurality of fixed segment numerals having a larger size than the first plurality of fixed segment numerals;
a user input device configured to receive a user input;
a control circuit communicably coupled to the sensor components, the display, and the user input device, wherein the control circuit is structured to, in a response to a user input selecting one of the plurality of sensor components, cause the second plurality of fixed segment numerals to display a value associated with the selected sensor component.

2. The sensor device of claim 1, wherein the control circuit is further structure to, in response to a user input to display an environmental condition value, cause the first plurality of fixed segment numerals to display a value of the environmental condition sensed by the selected sensor component.

3. The sensor device of claim 1, wherein the control circuit is further structured to, in response to a user input to display an environmental condition value, cause the second plurality of fixed segment numerals to display a value of the environmental condition sensed by the selected sensor component.

4. The sensor device of claim 1, wherein the control circuit is further structured to, in response to a user input to display a set point value, cause the first plurality of numerals to display a set point for the environmental condition associated with the selected sensor component.

5. The sensor device of claim 1, wherein the control circuit is further structured to, in response to a user input to display a set point value, cause the second plurality of numerals to display a set point for the environmental condition associated with the selected sensor component.

6. The sensor device of claim 1, wherein the plurality of sensor components comprises:
a temperature sensor configured to sense temperature in the building zone;
a humidity sensor configured to sense humidity in the building zone; and
a carbon dioxide sensor configured to sense the carbon dioxide level in the building zone; and
wherein, the plurality of fixed segment icons comprises:
a temperature icon associated with the temperature sensor;
a humidity icon associated with the humidity sensor; and
a carbon dioxide icon associated with the carbon dioxide sensor.

7. The sensor device of claim 6, wherein the plurality of sensor components further comprises an occupancy sensor configured to sense the presence of a person in the building zone.

8. The sensor device of claim 1, wherein the control circuit is configured to, in response to a user input selecting for display one of the plurality of fixed segment icons, cause the selected fixed segment icon and the associated fixed segment numeral to illuminate.

9. The sensor device of claim 8, wherein the control circuit is configured to, in response to a user input deselecting for display one of the plurality of fixed segment icons, cause the deselected fixed segment icon and the associated fixed segment numeral to darken.

10. The sensor device of claim 1, wherein the display comprises a touch-sensitive display including an up button, a down button, and a menu button.

11. The sensor device of claim 10, wherein the display further includes a fixed segment temperature display arranged to indicate either degrees Celsius or degrees Fahrenheit.

12. The sensor device of claim 11, wherein the control circuit is structured to, in response to the up button and the down button being simultaneously pressed for a predetermined amount of time, cause the display to enter into a configuration mode;
wherein, with the display in the configuration mode, the control circuit is structured to in response to a press of the menu button change from a first edit mode for changing the fixed segment temperature display between degrees Celsius and degrees Fahrenheit to a second edit mode for changing a different display feature.

13. The sensor device of claim 12, wherein the second edit mode is for changing each of the fixed segment graphic icons between an illuminated state and a darkened state.

14. The sensor device of claim 12, wherein, in the first edit mode, the control circuit is structured to cycle between degrees Celsius and degrees Fahrenheit in response to a press of either the up button or the down button.

15. A sensor device for use in a room, comprising:
a temperature sensor configured to sense temperature in the room;
a humidity sensor configured to sense humidity in the room;
a carbon dioxide sensor configured to sense the carbon dioxide level in the room;
a touch-sensitive display including:
a fixed segment temperature icon associated with the temperature sensor;
a plurality of fixed segment temperature value numerals located next to the fixed segment temperature icon;
a fixed segment humidity icon associated with the humidity sensor;
a plurality of fixed segment humidity value numerals located next to the fixed segment humidity icon;
a fixed segment carbon dioxide icon associated with the carbon dioxide sensor;
a plurality of fixed segment carbon dioxide numerals located next to the fixed segment carbon dioxide icon;
a plurality of large fixed segment numerals, the plurality of large fixed segment numerals having a larger size than the fixed segment temperature value numerals, the fixed segment humidity value numerals, and the fixed segment carbon dioxide numerals;
a plurality of touch sensitive buttons configured to receive a user input; and
a control circuit communicably coupled to the temperature sensor, the humidity sensor, the carbon dioxide sensor, and the display, wherein the control circuit is structured to, in a response to a user input selecting one of the temperature sensor, the humidity sensor, the carbon dioxide sensor, cause the plurality of fixed segment numerals to display a value associated with the selected sensor.

16. The sensor device of claim 15, wherein the control circuit is further structured to, in response to a user input to display an environmental condition value, cause the plurality of large fixed segment numerals to display a value of the environmental condition sensed by the selected sensor.

17. The sensor device of claim 15, wherein the control circuit is further structured to, in response to a user input to display a set point value, cause the plurality of large fixed segment numerals to display a set point for the environmental condition associated with the selected sensor.

18. The sensor device of claim 15, further comprising an occupancy sensor configured to sense the presence of a person in the room.

19. The sensor device of claim 15, wherein the control circuit is configured to, in response to a user input selecting for display one of the fixed segment temperature icon, the fixed segment humidity icon, and the fixed segment carbon dioxide icon, cause the selected fixed segment icon and the associated plurality of fixed segment numerals to illuminate.

20. The sensor device of claim 19, wherein the control circuit is configured to, in response to a user input deselecting for display one of the fixed segment temperature icon, the fixed segment humidity icon, and the fixed segment carbon dioxide icon, cause the deselected fixed segment icon and the associated plurality of fixed segment numerals to darken.
